(19) United States
(12) Patent Application Publication
(10) Pub. No.: US 2012/0159917 A1
(43) Pub. Date: Jun. 28, 2012

(54) Twisted Stalk Chopping Knives For Corn Headers

(75) Inventor: Randy Lohrentz, Buhler, KS (US)

(73) Assignee: AGCO CORPORATION, Duluth, GA (US)

(21) Appl. No.: 13/212,386

(22) Filed: Aug. 18, 2011

Related U.S. Application Data
(60) Provisional application No. 61/425,804, filed on Dec. 22, 2010.
(60) Provisional application No. 61/425,836, filed on Dec. 22, 2010.
(60) Provisional application No. 61/425,887, filed on Dec. 22, 2010.
(60) Provisional application No. 61/425,907, filed on Dec. 22, 2010.
(60) Provisional application No. 61/425,920, filed on Dec. 22, 2010.
(60) Provisional application No. 61/425,935, filed on Dec. 22, 2010.
(60) Provisional application No. 61/426,072, filed on Dec. 22, 2010.
(60) Provisional application No. 61/426,119, filed on Dec. 22, 2010.
(60) Provisional application No. 61/426,141, filed on Dec. 22, 2010.
(60) Provisional application No. 61/426,167, filed on Dec. 22, 2010.
(60) Provisional application No. 61/426,193, filed on Dec. 22, 2010.
(60) Provisional application No. 61/426,213, filed on Dec. 22, 2010.
(60) Provisional application No. 61/426,234, filed on Dec. 22, 2010.
(60) Provisional application No. 61/426,263, filed on Dec. 22, 2010.
(60) Provisional application No. 61/426,277, filed on Dec. 22, 2010.
(60) Provisional application No. 61/426,300, filed on Dec. 22, 2010.
(60) Provisional application No. 61/426,090, filed on Dec. 22, 2010.

(51) Int. Cl. A01D 45/02

(52) U.S. Cl. 56/60

(57) ABSTRACT

A knife for cutting crop stalks and impacting the cut crop stalks to prevent damage to the tires of agricultural vehicles. Leading and trailing edges of the knife oppose one another and define a trailing face therebetween. The leading edge is higher than the trailing edge to cut stalks and the tailing edge is angled downward in trailing relationship to the leading edge so that as the knife cuts a crop stalk the trailing face also impacts the cut stalk to force it downward to the ground.

### CROSS REFERENCE TO RELATED APPLICATIONS

The present application claims the benefit of co-pending U.S. provisional application entitled “CANTILEVERED GATHERING AUGER FOR CORN HEADER (P1193H)”, having Ser. No. 61/425,804, filed Dec. 22, 2010; of co-pending U.S. provisional application entitled “PIVOTING GATHERING AUGER FOR CORN HEADER (P1171H)”, having Ser. No. 61/425,836, filed Dec. 22, 2010; of co-pending U.S. provisional application entitled “CROP CAPTURING MEMBER FOR CORN HEADER WITH GATHERING AUGER (P1172H)”, having Ser. No. 61/425,887, filed Dec. 22, 2010; of co-pending U.S. provisional application entitled “GATHERING AUGER WITH INDEPENDENT SPEED (P117311)”, having Ser. No. 61/425,907, filed Dec. 22, 2010; of co-pending U.S. provisional application entitled “COMBINATION DRIVEN AND IDLER SNAP ROLLS FOR CORN HEADER (P1174H)”, having Ser. No. 61/425,920, filed Dec. 22, 2010; of co-pending U.S. provisional application entitled “SPRING LOADED SNAP ROLL FOR CORN HEADER (P1175H)”, having Ser. No. 61/425,935, filed Dec. 22, 2010; of co-pending U.S. provisional application entitled “HELICAL ACTING SNAP ROLL FLUTES FOR CORN HEADER (P1176H)”, having Ser. No. 61/426,072, filed Dec. 22, 2010; of co-pending U.S. provisional application entitled “TILTING CROP STALK CHOPPER (P1177H)”, having Ser. No. 61/426,090, filed Dec. 22, 2010; of co-pending U.S. provisional application entitled “REMOVABLE CORN HEADER SNOUT (P117811)”, having Ser. No. 61/426,119, filed Dec. 22, 2010; of co-pending U.S. provisional application entitled “OFFSET SNAP ROLLS FOR CORN HEADER (P117911)”, having Ser. No. 61/426,141, filed Dec. 22, 2010; of co-pending U.S. provisional application entitled “DUAL IDLER ROLLS FOR CORN HEADER (P118011)”, having Ser. No. 61/426,167, filed Dec. 22, 2010; of co-pending U.S. provisional application entitled “SNAP ROLLS WITH HELICAL FLUTES FOR CORN HEADER (P1181H)”, having Ser. No. 61/426,193, filed Dec. 22, 2010; of co-pending U.S. provisional application entitled “SMOOTH IDLER ROLL FOR CORN HEADER (P1182H)”, having Ser. No. 61/426,213, filed Dec. 22, 2010; of co-pending U.S. provisional application entitled “OFFSET STRIPPER PLATES FOR CORN HEADER (P1183H)”, having Ser. No. 61/426,234, filed Dec. 22, 2010; of co-pending U.S. provisional application entitled “METHOD FOR URGING CROP STALKS INTO A GATHERING AUGER FOR A CORN HEADER (P1184H)”, having Ser. No. 61/426,263, filed Dec. 22, 2010; of co-pending U.S. provisional application entitled “HELICAL ACTING STRAIGHT SNAP ROLL FLUTES FOR CORN HEADER (P1185H)”, having Ser. No. 61/426,277, filed Dec. 22, 2010; of co-pending U.S. provisional application entitled “TWISTED STALK CHOPPING KNIVES (P1190H)”, having Ser. No. 61/426,300, filed Dec. 22, 2010; which are all incorporated herein by reference.

### TECHNICAL FIELD

This invention relates to cutting and gathering stalk crops such as corn with a header coupled to an agricultural vehicle.

### BACKGROUND

Agricultural harvesters such as combines are typically equipped with a harvesting header. Corn headers are specifically designed to pick corn and vary in size from two-row units to twelve-row units or more. As the harvester moves through the field, each row-unit passes between rows of corn. Corn header row units typically use gathering chains to covey crop material and ears rearward toward a cross auger. A set of driven snap rolls, which rotate based on the speed of the harvester, grabs the corn stalks and forces them downward between stripper plates. The ears of corn are snapped free of the stalk and the cross auger passes the ears to the feeder housing of the harvester. If the snap rolls are operated too fast or too slow, ears of corn may be lost or entire corn stalks may be passed to the cross auger and feeder housing.

Known row units require two gathering chains and two tensioners which are heavy, expensive and wear out easily. Furthermore, the gathering chains create a complicated drive mechanism because the axes of the drive sprockets driving the chains are at right angles to the axes of the snap rolls. Also, the gathering chains do not effectively convey a large mass of crop in conditions when material other than ears of corn, such as stalks and leaves, are severed from the ground. What is needed is a simpler and more cost effective row unit that is capable of conveying a large mass of crop.

### BRIEF DESCRIPTION OF THE DRAWINGS

The accompanying drawings, which are incorporated in and constitute a part of this disclosure, illustrate various embodiments of the present invention. In the drawings:

FIG. 1 shows a perspective view of a corn header having a plurality of row units for an agricultural vehicle;

FIG. 2 shows a top view of the header of FIG. 1;

FIG. 3 shows a close-up view of a portion of the header of FIG. 1;

FIG. 4 shows a portion of the bottom of the header of FIG. 1;

FIG. 5 shows a close-up view of a portion of the bottom of the header of FIG. 1;

FIG. 6 shows a perspective view of a frame which forms part of a live row unit and part of an adjacent dead row unit;

FIG. 7 shows a perspective view of a conventional gathering chains and gearbox but with the twisted stalk chopping knives of the present invention;

FIG. 8 shows the orientation of the leading and trailing edges of a conventionally oriented knife of a chopper; and

FIG. 9 shows the orientation of the leading and trailing edges of a knife of the present invention.

### DESCRIPTION OF EXAMPLE EMBODIMENTS

The present invention is susceptible of embodiment in many different forms. While the drawings illustrate and the specification describes certain preferred embodiments of the invention, it is to be understood that such disclosure is by way of example only. There is no intent to limit the principles of the present invention to the particular disclosed embodiments. References hereinafter made to certain directions, such as, for example, “left” and “right”, are made as viewed from the front looking rearward.

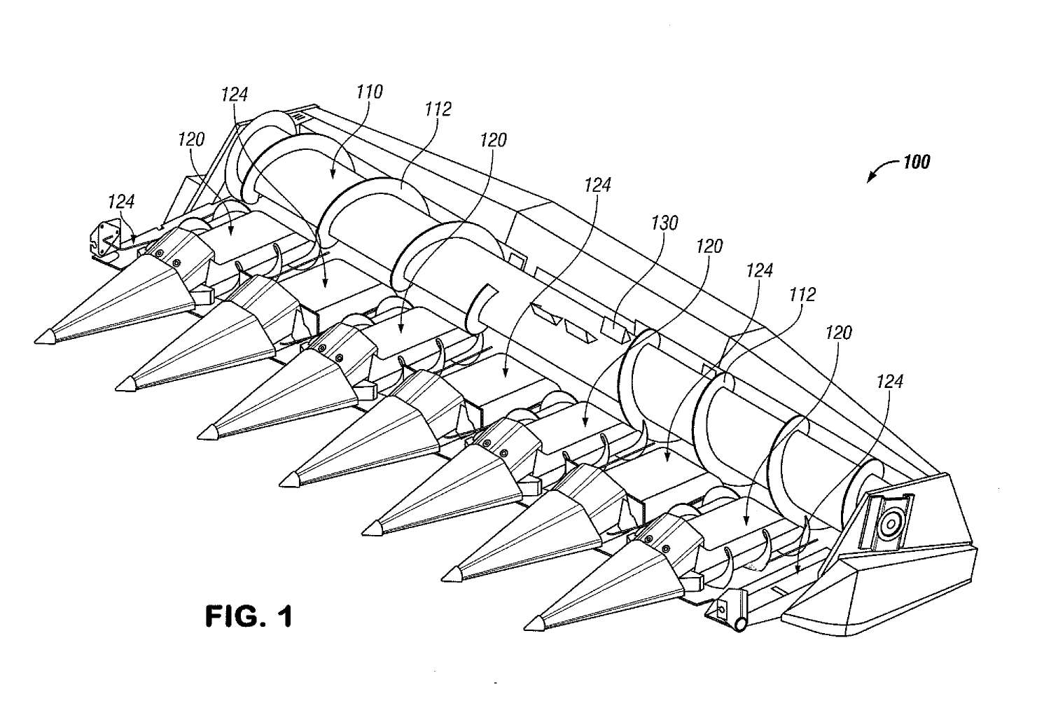

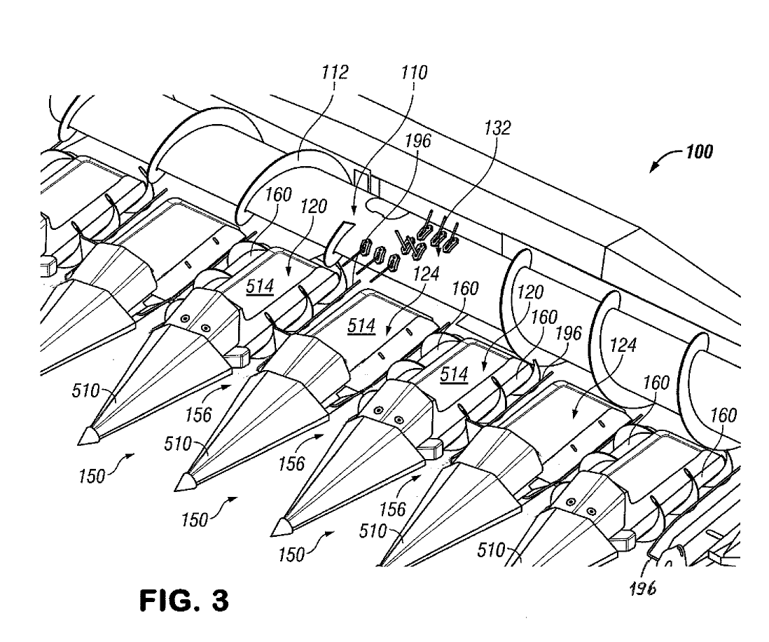

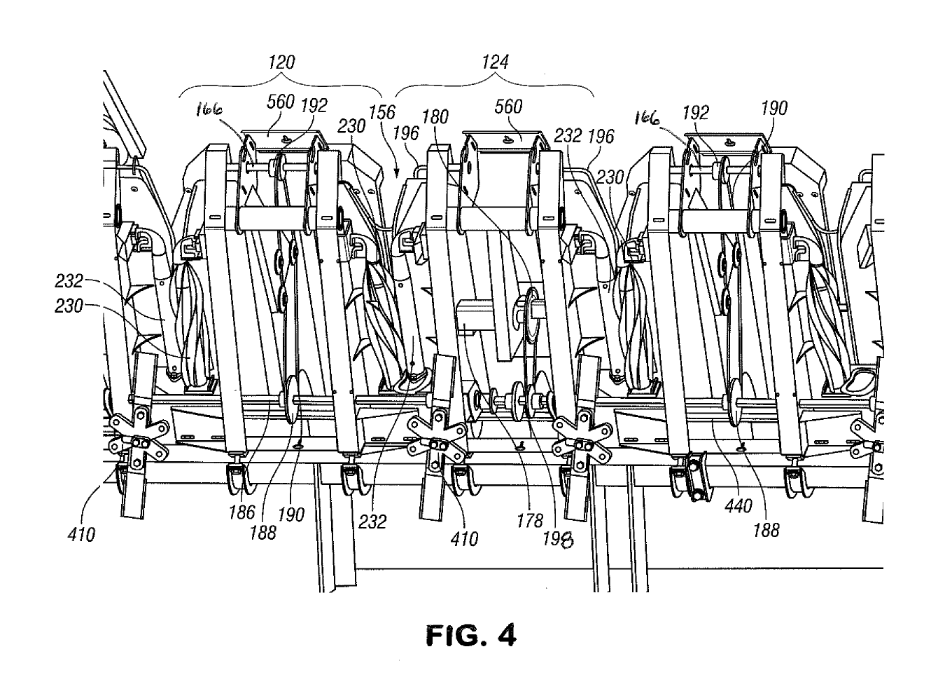

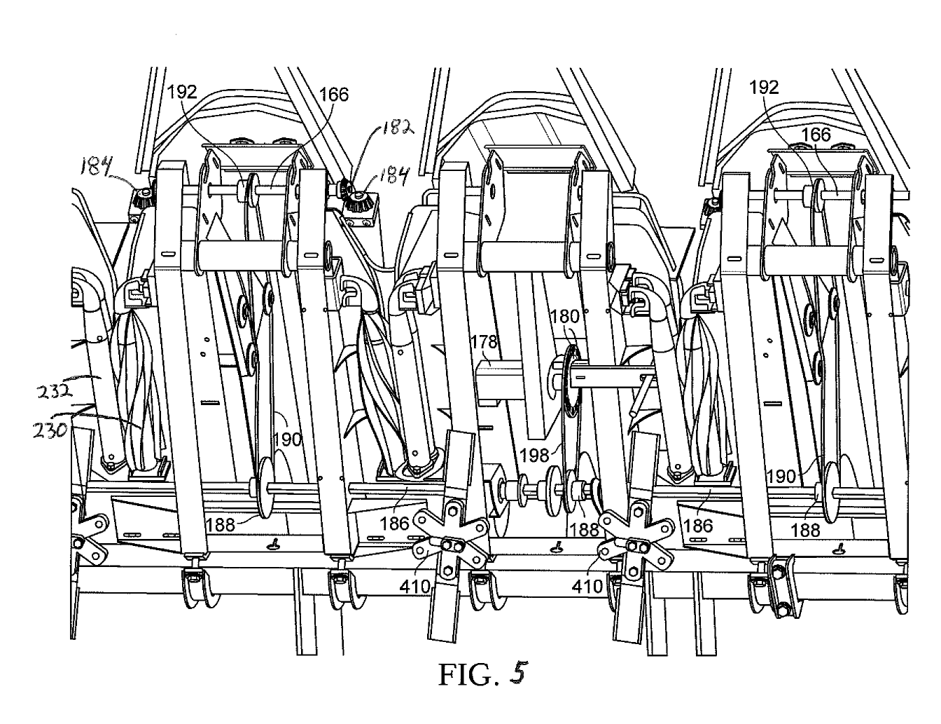

The exemplary header 100 selected for illustration in FIGS. 1-5 has a cross auger 110 with spiral flighting 112 for sweeping the ears of corn toward the center of the header 100. Large cross augers 110 may also have paddles 130, fingers 132 or some other means to facilitate the delivery of the crop rearward to the feeder housing of a harvester. The header 110 has a plurality of forward-extending live row-units 120 and a plurality of forward-extending dead row units 124. The row units 120, 124 and the cross auger 110 define a feeder plane therebetween where useable parts of stalk crops are conveyed rearward from the row units 120, 124 to the cross auger 110.

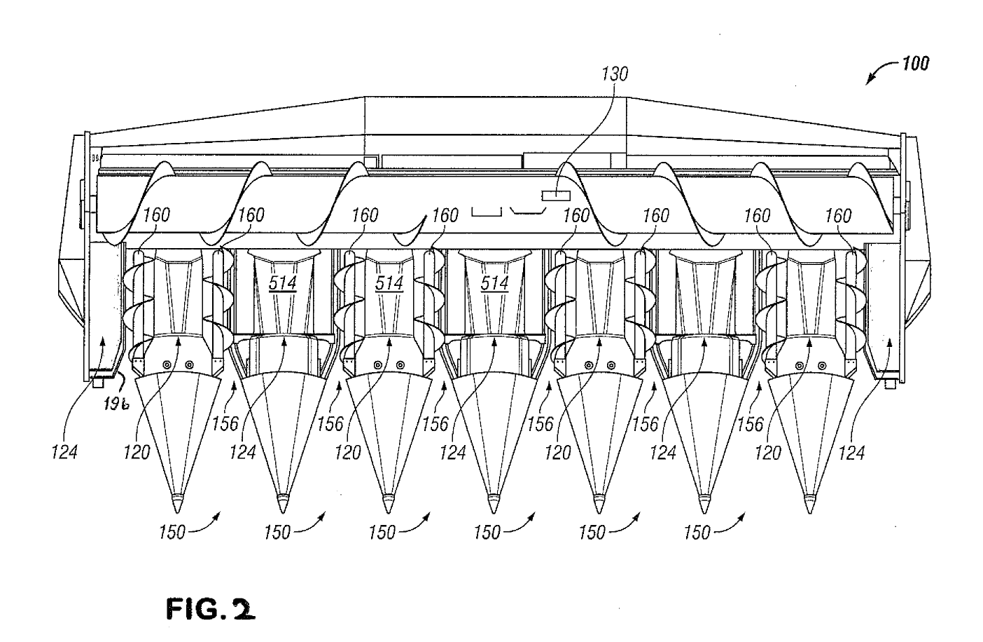

Live row units 120 and dead row units 124 cooperate with one another. Live row units 120 have powered components, as described in greater detail below, whereas the dead row units 124 generally do not have powered components. In one embodiment, as best shown in FIGS. 1 and 2, the header 110 has four live row units 120, three dead row units 124, plus one half of a dead row unit 130 on each end of the header 110. The row units 120, 124 are arranged relative to one another so that the row units 120, 124 alternate relative to each other along the length of the header 110. In other words, every other row unit is a live row unit 120 with a dead row unit 124 adjacent to each live row unit 120. The row units 120, 124 are spaced relative to one another to correspond with the spacing of the crop to be harvested and to provide a path to receive the crop therebetween. For example, a live row unit 120 may be placed between two dead row units 124 to cooperate therewith.

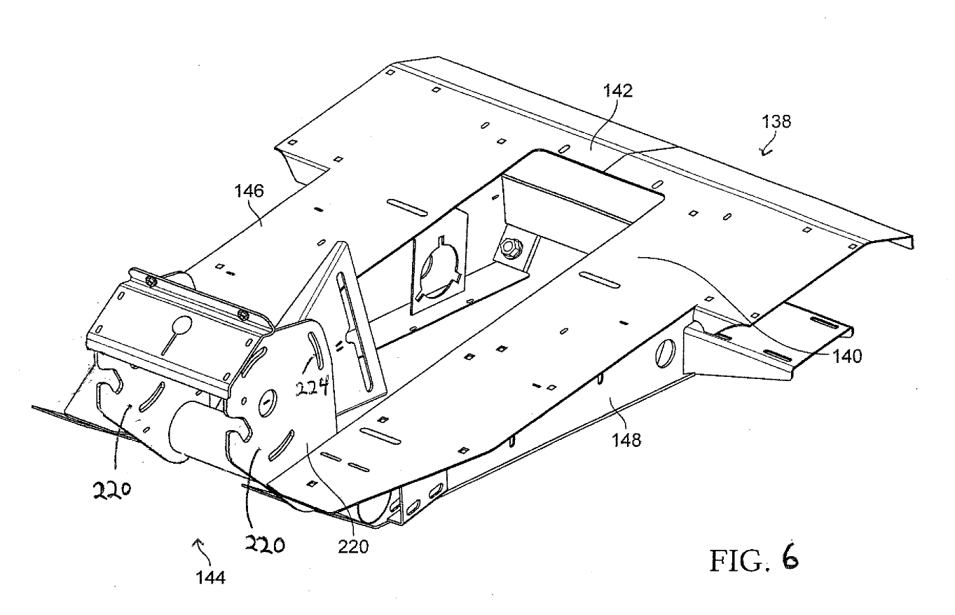

FIG. 6 illustrates a row assembly 138 having a frame 140, a back end 142 and a forward end 144. Half of the frame 140 forms part of a live row unit 120 and the other half forms part of a dead row unit 124. Therefore, one live row unit 120 includes two halves of two separate and adjacent frames 140. One dead row unit 124 includes two halves of two separate and adjacent frames. Each frame 140 includes a first portion 146 and a second portion 148 which are spaced from one another and protrude outwardly and forward from the back end 142. At the front and between adjacent row units 120, 124 is a crop entry 150 for receiving the stalks of the crop. The first and second portions 146,148 receive stripper plates which cooperate with one another to define the crop passage 156 between adjacent row units 120, 124. The stripper plates strip useable parts such as ears of corn from crop stalks that are received in the crop passage 156.

Each live row unit 120 of the present invention includes at least one fore-to-aft gathering auger 160, in place of the two gathering chains and tensioners, for conveying the useable parts rearward to the cross auger 110. Each gathering auger 160 has a proximal end and a distal end and is preferably aligned substantially with a corresponding crop passage 156. However, the axis of rotation of the gathering auger 160 may instead be misaligned with the crop passage 156 such that the crop stalks in the back of the crop passage may be urged more so toward the gathering auger 160 than the crop stalks are at the beginning of the crop passage 156.

Preferably, each live row unit 120 includes a pair of counter-rotating augers 160. The dead row units 124, on the other hand, do not include gathering augers 160 or any gathering chains. Therefore, the complexity of the header 110 is reduced by utilizing gathering augers 160 on live row units 120 instead of gathering chains and tensioners. Also, by utilizing dead row units 124 in combination with the live row units 120 the overall complexity of the header 110 is substantially reduced because the dead row units 124 do not have gathering augers 160 or gathering chains and tensions and also because the drive means for driving the gathering augers 160 is simpler than known drives used in combination with gathering chains.

The gathering augers 160 are preferably driven independently of the snap rolls. The gathering auger 160 may be driven by electrical, mechanical or hydraulic means. Preferably, each gathering auger 160 is cantilevered from the frames 140 and rotationally driven from the forward most end of its respective row unit 120 away from the cross auger 110 rather than the rear of the row unit 120 in close proximity to the cross auger 110 so that the delivery or the distal end of the gathering auger 160 is not obstructed. This allows ears and stalks to be delivered to the cross auger 110 unimpeded by bearing supports, drive mechanisms or some other crop impeding structure.

An arrangement of gears or wheels such as bevel gears 182, 184 may be used for transmission of the driving motion to the gathering auger 160 from a driven shaft 166 within each live row unit 120 while also allowing the distal end of the gathering auger 160 to pivot upward about the same axis of the shaft 166. Each shaft 166 preferably drives a pair of gathering augers 160 of a single live row unit 120 so that the pair of gathering augers are driven about the same axis about which they may pivot into and out of the feeder plane. When the gathering auger 160 is pivoted upward, fasteners may be removed from the auger 160 so that the outer flighting portion of the gathering auger 160 may slide rearward so that it may be removed from an inner shaft and from cylindrical bearings allowing the flighting portion to rotate about the inner shaft.

The distal end of the gathering auger 160 is coupled to the bevel gear 182 which is driven by the bevel gear 184 on shaft 166. The shaft 166 may be chain driven by a hydraulic drive motor 178 with sprocket 180. Preferably, the drive motor 178 is sufficiently sized to drive all of the gathering augers 160. The drive motor 178 and sprocket 180 with chain 198 drives sprocket 188 and shaft 186 which extends in a transverse manner along the length of the header 100. There are preferably numerous other sprockets 188 along the length of the shaft 186. The number of sprockets 188 depends on the number of live row units 120. Chains 190 extend from the sprockets 188 of the shaft 186 to sprockets 192 on shaft 166.

Because the augers 160 are driven by the drive motor 178, the speed of the augers 160 is independent of the speed of the cross auger 110. The chain 190 driving the sprocket 192 which in turn drives the shaft 166 with bevel gears 182. The speed of the augers 160 can be changed automatically or manually in relation to the ground speed much like current grain headers on harvesters that control reel speed. Moreover, the augers 160 can be driven independent of the snap rolls. The speed of the gathering augers 160 may be varied while either or both the harvester and the snap rolls are maintained at a constant speed.

In addition to the apparatuses described herein, the inventions include a method for harvesting crop with an attachment for an agricultural vehicle that includes the gathering augers 160. The method includes operating the gathering augers 160 at a first speed to gather crop stalks in the crop passages 156 and operating a snap roll for removing useable parts from crop stalks at a second speed independently of the gathering augers 160. The method may also include one or more of the following steps: varying the speed of the gathering augers 160 while the speed of the snap rolls remain constant, increasing the speed of the gathering augers 160 while the speed of the snap rolls remain constant, decreasing the speed of the gathering augers 160 while the speed of the snap rolls remain constant, varying the speed of the snap rolls while the speed of the gathering augers 160 remain constant, increasing the speed of the snap rolls while the speed of the gathering augers 160 remain constant, decreasing the speed of the snap rolls while the speed of the gathering augers 160 remain constant, and/or changing the speed of the gathering augers 160 relative the ground speed of the harvester.

To keep stalks captured and engaged by the gathering auger 160 an elongated member 196 such as a rod is positioned in close proximity to the flighting of the gathering auger 160. Preferably, the elongated member 196 is substantially parallel aligned with the gathering auger 160. However, in other embodiments, at least a portion of the elongated member 196 may be shaped or curved along its length or the distal end of the elongated member 196 may be closer in proximity to the distal end of the gathering auger 160. The elongated member 196 may be rigid, flexible, or semi-flexible to urge the stalks in the crop passage toward the gathering auger 160. In one or more embodiments, the elongated member 196 is cantilevered off the forward end 144 of the frame 136 of the dead row unit 124 to urge the stalks in the crop passage 156 toward the gathering auger 160 of the opposing live row unit 120. The dead row unit may also include a second elongated member 196 extending toward another gathering auger 160 of another live row unit. In an alternative embodiment, the elongated member 196 may be a strap or be detachably coupled or mounted to a row unit.

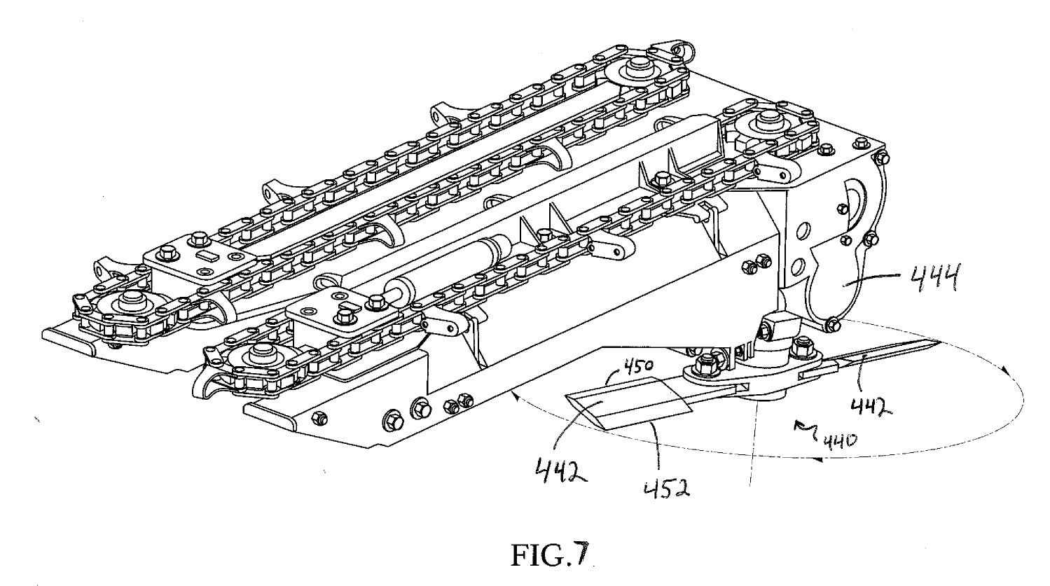

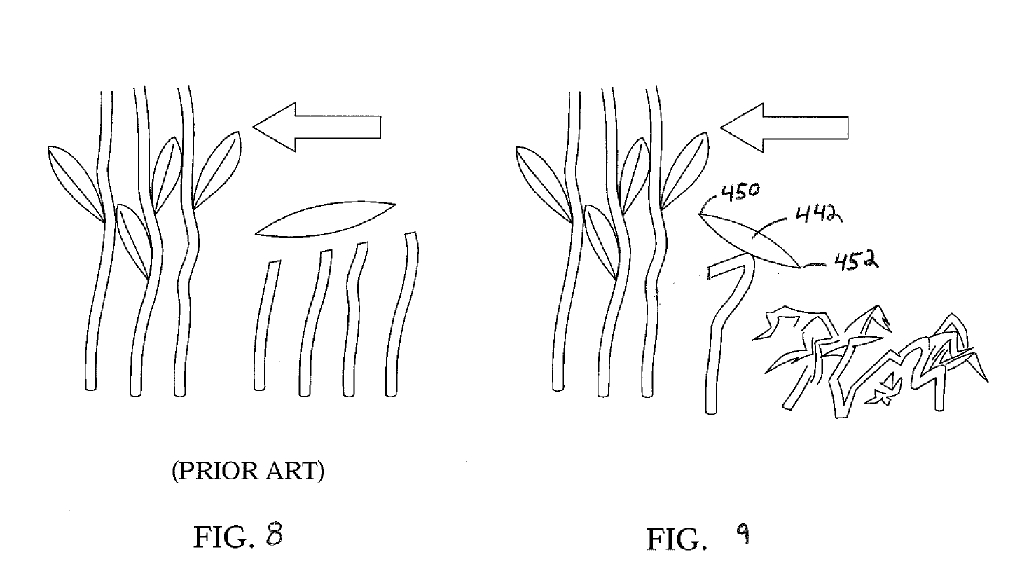

Referring now to FIGS. 7-9, one or more embodiments of the present invention may include choppers 440 with knives 442 coupled to a conventional gearbox 444 as shown in FIG. 7. The gearbox 444 may be fixed to conventional row units with gathering chains, but the chopper 440 with knives 442 may instead be used with tiltable gearboxes 420 as well as with row units of the present invention with the gathering augers 160. The knives 442 may appear to be similar to convention mover blades having leading edges that are lower than trailing edges so that when it cuts the trailing face elevates the cut portions to generate a mulching effect. Utilizing conventional knives leaves a field full of stalk stubble that is about 6 inches tall with sharp tips that damage tires as best shown in FIG. 8. Farmers sometimes then add stalk stompers which flatten the stubble but they are heavy, expensive, and cumbersome when loading the header on a trailer for transport.

On the other hand, each knife 442 of the present invention forces the tops of the stalk stubble downward to the ground so that tires can no longer be damaged. As best shown in FIGS. 7 and 9, each knife 442 has a leading edge 450 that opposes a trailing edge 452 where as a result of the twist of the knife 442 relative the direction of rotation the leading edge 450 is higher than the trailing edge 452 to define a somewhat downwardly oriented trailing face 456 therebetween. The trailing edge 452 is angled downward in trailing relationship to the leading edge 450 so that when the knife 442 cuts stalks with its leading edge 450 the trailing face 456 also impacts the cut stalk to force it downward to the ground as shown in FIG. 9. The trailing face 456 also may split or shatter the cuts stalks thereby further reducing the chances of a punctured tire.

A pair of knives 442 may be coupled to the chopper at their proximal ends so that each knife 442 extends radially outward and that the knives 442 rotate about a rotational axis defined by the chopper 440 and gearbox. Alternatively, an elongated blade may define a pair of distal portions extending in opposite directions from a central portion for mounting the blade to the chopper 440 in a rotational manner. Each opposite portions defines a knife 442 with leading and trailing edges 450, 452 and a trailing face 456. One opposite portion with knife 442 is twisted in a first direction relative a plane of the central portion and the other opposite portion with knife 442 is twisted in a second direction so that leading edges 450 of each knife 442 is presented higher than its corresponding trailing edge 452.

In addition to the knife 442 itself, described herein, the inventions include a method for chopping stalk crops while harvesting with an agricultural vehicle. The method includes the steps of gathering crop stalks in a crop passage and removing useable parts from the crop stalks gathered in the crop passage. The method further includes the steps of cutting the stripped crop stalks with a leading edge of a knife and as the knife cuts the stalk the trailing face of the knife impacts the cut crop to force them downward to the ground to prevent the tires of the agricultural vehicle from being punctured as it passes over the cut crop stalks. As a result of the impacting step, the cut crop stalks may also be shattered or split.

The foregoing has broadly outlined some of the more pertinent aspects and features of the present invention. These should be construed to be merely illustrative of some of the more prominent features and applications of the invention. Other beneficial results can be obtained by applying the disclosed information in a different manner or by modifying the disclosed embodiments. Accordingly, other aspects and a more comprehensive understanding of the invention may be obtained by referring to the detailed description of the exemplary embodiments taken in conjunction with the accompanying drawings, in addition to the scope of the invention defined by the claims.

What is claimed is:

1. A stalk cutting knife for a chopper of a harvesting header, said knife comprising first leading and trailing edges opposing one another and defining a first trailing face therebetween, said first leading edge higher than said first trailing edge to cut stalks, and said first trailing edge angled downward in trailing relationship to said first leading edge such said first trailing face impacts the cut stalk.

2. The stalk cutting knife of claim 1 wherein said knife comprises a central portion in a plane and a pair of opposite portions extending in diagonally opposite directions from said central portion, a first portion of said pair of opposite portions defining said first leading and trailing edges and said first trailing face, and a second portion of said pair of opposite portions defining second leading and trailing edges and a second trailing face therebetween, said second leading edge higher than said second trailing edge to cut stalks, and said second trailing edge angled downward in trailing relationship to said second leading edge such that said second trailing face impacts the cut stalk.

3. The stalk cutting knife of claim 2 wherein said first opposite portion is twisted from said plane of said central portion in a first direction to present said first leading edge higher than said first trailing edge and said second opposite portion is twisted from said plane of said central portion in a second direction to present said second leading edge higher than said second trailing edge.

4. The stalk cutting knife of claim 2 wherein said first and second trailing faces force the cut stalk downward.

5. The stalk cutting knife of claim 2 wherein said first and second trailing faces shatter the cut stalk.

6. The stalk cutting knife of claim 2 wherein said first and second trailing faces split the cut stalk.

7. The stalk cutting knife of claim 1 wherein said knife extends radially outward from a rotational axis.

8. The stalk cutting knife of claim 1 wherein said a portion of said knife is twisted to present said first leading edge higher than said first trailing edge.

10. The stalk cutting knife of claim 1 wherein said first trailing face forces the cut stalk downward.

11. The stalk cutting knife of claim 1 wherein said first trailing face shatters the cut stalk.

12. The stalk cutting knife of claim 1 wherein said first trailing face splits the cut stalk.

13. A method of chopping stalk crops while harvesting with an agricultural header, said method comprising the steps of:
gathering crop stalks in a crop passage;
removing useable parts from crop stalks gathered in said crop passage;
cutting the crop stalks with a leading edge of a knife; and
impacting the cut crop stalks with a trailing face of said knife.

14. The method of claim 13 further comprising the step of forcing the cut crop stalks downward toward the ground as a result of said impacting step.

15. The method of claim 13 further comprising the step of shattering the cut crop stalks as a result of said impacting step.

16. The method of claim 13 further comprising the step of splitting the cut crop stalks as a result of said impacting step.

17. A method of chopping stalk crops with an agricultural header, said method comprising the steps of:
cutting the crop stalks with a higher leading edge of a knife; and
impacting the cut crop stalks with a lower trailing face of said knife.

18. The method of claim 17 further comprising the steps of forcing the cut crop stalk downward as a result of said impacting step such that tires of an agricultural vehicle with the header passes over the cut crop stalks without damaging the tires.
